(19) United States
(12) Patent Application Publication
(10) Pub. No.: US 2015/0324160 A1
(43) Pub. Date: Nov. 12, 2015

(54) Network Printing Device, Server, System and Method

(71) Applicant: Sitao DING, Beijing (CN)

(72) Inventor: Sitao DING, Beijing (CN)

(21) Appl. No.: 14/703,815

(22) Filed: May 4, 2015

(30) Foreign Application Priority Data
May 6, 2014 (CN) 201410187388.0

(51) Int. Cl. G06F 3/12

(52) U.S. Cl. CPC G06F 3/1268; G06F 3/1285

(57) ABSTRACT

A network print server, a network printing device and the corresponding print method and system are disclosed. The server comprises a print task memory, a printing device registration unit, and a print task management unit. The print task memory stores a print task list. The printing device registration unit establishes, in response to a request of a printing device, a network connection to the printing device, registers the printing device and creates in the print task memory a print task list corresponding to the printing device. The print task management unit receives a print request from a computing device and adds a print task entry in the print task list of the requested printing device. The print task entry comprises a print task ID and print task content.

### CROSS-REFERENCE TO RELATED APPLICATIONS

The present application is a continuation of, and claims priority to, Chinese patent application No. CN 201410187388.0 filed May 6, 2014, the disclosure of which is hereby incorporated by reference in its entirety.

### BACKGROUND

Printer is a commonly seen device in an office environment, which is mainly operated to print computer-processed results on a related medium. Currently network printing inside a local network becomes ordinary and some organizations, e.g., corporations and schools, even arrange a dedicated printer server enabling a user to install a printer client driver on his/her computer and thus print files (e.g., photos, documents, etc.) stored in the computer using a printer managed by the printer server. Since the computer, the printer and the printer server are all situated within the local network, which form a closed system for the organizations, it is easy to perform the security management and the printing for the print tasks.

However, a print user may also be located outside a local network in many circumstances. For instance, when a user on a business trip browses emails on a portable computing device such as a laptop computer, a smart phone, or a tablet computer, he/she may hope to print the content of the emails on a printer of the hotel where he/she stays. The user may add the device to the local network of the hotel to connect with the printer and install a corresponding printer driver to print the emails. Apparently, this is not convenient because the hotel may not be willing to open its local network to the public, and may also require complicated set-ups even if adding to the local network is allowed for users. Moreover, it often takes time and efforts to seek and install the driver for a certain printer model. In particular when the user uses a mobile terminal like a smart phone, possibly no corresponding driver(s) has/have been developed for such mobile terminals. Nowadays, with the rapid development of mobile internet techniques, the user expects a more flexible and efficient printing implementation, rather than that of the traditional local networks.

The concept of domain has been introduced in the Windows® operation system by Microsoft, and computing devices and printers in different networks can join the same domain to share the printers. However, this requires complicated network set-ups, and it is still necessary to install corresponding printer drivers on the computing devices, which is still difficult for mobile terminals like smart phones.

There is also a GPRS wireless printer available. The GPRS printer is connected to the Internet via a GSM SIM card to acquire a globally unique IP address and convert the received texts such as SMS messages according to the RS232 standard for printing. Nevertheless, as the SIM card communicates based on the GPRS standard, the network connection is quite slow and only suitable for printing some simple texts. In addition, due to the limit of the total number of the available IP addresses, the current 4G communication standard cannot afford assignment to each SIM card a globally unique IP address, and problems may arise during the establishment of the connections.

So there is a need for a more flexible and efficient network printing technique.

### SUMMARY

The present invention relates to network printing techniques, especially to a network printing device, a network print server, system and the corresponding printing method.

To this end, the present disclosure provides a new network printing device, a network printing system and a corresponding printing method, in an attempt to solve or at least alleviate the problem above.

According to one aspect of the present invention, a network print server is provided. The network print server comprises: a print task memory configured to store a print task list; a printing device registration unit configured to establish, in response to a request of a printing device, a network connection to the printing device, register the printing device and create in the print task memory a print task list corresponding to the printing device; and a print task management unit configured to receive a print request from a computing device and add a print task entry in the print task list of the requested printing device, the print task entry comprising a print task ID and print task content. The print task management unit is further configured to receive from the printing device a request to download a print task and send the requested print task to the printing device.

The network connection between the network print server and the printing device may be established via a virtual private network (VPN). The print task management unit may be further configured to receive an inquiry from the printing device about the latest print task ID in the print task list and return the latest print task ID to the printing device. The print task management unit may be further configured to push the latest print task ID in the print task list to the corresponding printing device. The print task management unit may be further configured to receive from the printing device a request to download at least one new print task, the at least one new print task corresponding to at least one print task ID subsequent to the current print task ID maintained in the printing device. The print task management unit may be further configured to send the new print task to the printing device. The printing device registration unit is configured to notify the printing device to connect to the network for registration or select an alternative printing device if the printing device is not connected or registered.

According to one aspect of the present invention, a network printing device is provided. The network printing device comprises: a network initialization unit configured to establish a network connection between the printing device and the network print server, and register the printing device at the network print server; and a print task management unit configured to compare the latest print task ID of the printing device provided by the network print server with the current print task ID maintained in the printing device, and request to download at least one new print task from the network print server if the two print task IDs are inconsistent, the at least one new print task corresponding to at least one print task ID subsequent to the current print task ID maintained in the printing device.

The network printing device may further comprise a printing unit for performing a print task assigned by the print task management unit. Alternatively, the network printing device may be situated outside of the printing unit, e.g., the network initialization unit and the print task management unit may be situated in a printing box, and the printing box may be connected with the printing unit, extending it to a network printing device.

The print task management unit may be further configured to inquire of the network print server periodically about the latest print task ID in the print task list and receive the inquired latest print task ID. The print task management unit may also be further configured to receive the latest print task ID in the print task list pushed by the network print server.

According to a further aspect of the present invention, a printing method of a network print server is provided. The method comprises: receiving a print request from a computing device; adding a print task entry in the print task list to which the target printing device of the print request corresponds, the print task entry comprising a print task ID and print task content; receiving from the printing device a request to download the print task; and sending the requested print task to the printing device.

The method may further comprise receiving an inquiry from the printing device about the latest print task ID in the print task list and returning the latest print task ID to the printing device. The method may further comprise pushing the latest print task ID in the print task list to the corresponding printing device. The step of receiving from the printing device the request to download the print task comprises receiving from the printing device a request to download at least one new print task, the at least one new print task corresponding to the print task ID subsequent to the current print task ID maintained in the printing device, wherein the step of sending the requested print task to the printing device comprises sending the new print task to the printing device. The method may further comprise establishing, in response to a request of the printing device, a network connection to the printing device, registering the printing device and creating a print task list corresponding to the printing device.

According to a further aspect of the present invention, a printing method of a network printing device is provided, comprising: establishing a network connection to a network print server; registering the network printing device at the network print server; comparing the latest print task ID of the printing device provided by the network print server with the current print task ID maintained in the printing device; and requesting to download at least one new print task from the network print server if the two print task IDs are inconsistent, the at least one new print task corresponding to at least one print task ID subsequent to the current print task ID maintained in the printing device.

The method may further comprise inquiring of the network print server periodically about the latest print task ID in the print task list and receiving the inquired latest print task ID. The method may further comprise receiving the latest print task ID in the print task list pushed by the network print server.

According to a further aspect of the present invention, a network printing system is provided, comprising the above network print server and at least one above network printing device.

In light of the network printing method according to the present invention, computing devices such as mobile terminals may simply print on a printing device via a public network without having to install a driver or join a corporation local network, which greatly facilitates the printing for a user, especially in a mobile environment. For a traditional printer, it just needs to be connected externally to a network print box to become a network printer, in which way the existing printing device is utilized to an utmost extent, which is cost-saving. Furthermore, the action of “push” or “pull” may be used flexibly to obtain a new print task from the network print server. A new print task may be obtained more rapidly by “pull” when the cloud print server is considerably burdened with a large number of printing devices. By “push”, it is unnecessary to send a great deal of inquiry messages, thereby not only reducing the burden of the cloud print server but also saving the communication traffic cost. The connection between the cloud print server and the printing device may be established via VPN such that the printing device receives the push from the cloud print server via the VPN and bypasses the interception of the firewall, thereby making the cloud printing by “push” feasible.

### BRIEF DESCRIPTION OF THE DRAWINGS

To the accomplishment of the foregoing and related ends, certain illustrative aspects are described herein in combination with the following description and the annexed drawings. These aspects are indicative of the various ways in which the principles disclosed herein can be practiced and all aspects and equivalents thereof are intended to be within the scope of the claimed subject matter. The foregoing and other goals, features and advantages of this disclosure will become more apparent from the following detailed description in conjunction with the drawings. Throughout this disclosure, the same reference signs usually refer to the same parts or elements.

FIG. 1 illustrates a schematic view of a cloud printing system 100 according to one embodiment of the present invention;

FIG. 2 illustrates a schematic view of a client interface of an online ordering application;

FIG. 3 illustrates a flow chart of a printing method 300 performed by a cloud print server 120 according to an exemplary embodiment of the present invention;

FIG. 4 illustrates a flow chart of a printing method 400 performed by a printing device 130 according to an exemplary embodiment of the present invention;

FIG. 5 illustrates a flow chart of a printing method 500 performed by a cloud print server 120 according to another exemplary embodiment of the present invention; and

FIG. 6 illustrates a flow chart of a printing method 600 performed by a printing device 130 according to another exemplary embodiment of the present invention.

### DETAILED DESCRIPTION

The exemplary embodiments of this disclosure will be described in a more detailed manner as follows with reference to the drawings. Although the exemplary embodiments of this disclosure are shown in the drawings, it should be understood that this disclosure can be implemented in various forms and should not be restricted by the embodiments described herein. On the contrary, these embodiments are provided to make this disclosure more thoroughly understood and the scope of the disclosure fully conveyed to those skilled in the art.

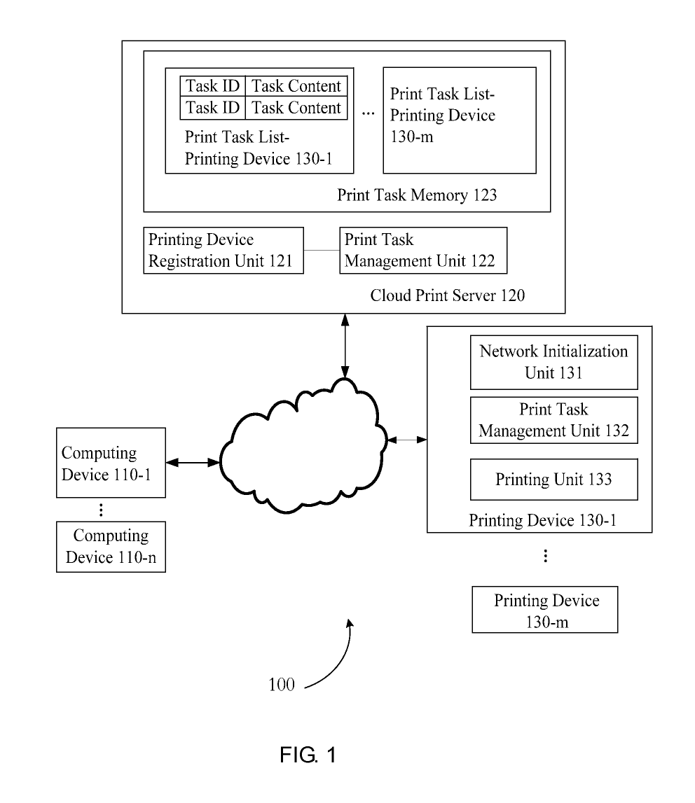

FIG. 1 illustrates a schematic view of a cloud printing system 100 according to an exemplary embodiment of the present invention. As shown in FIG. 1, the cloud printing system 100 comprises one or more computing devices 110-1, 110-2, . . . , 110-n (hereinafter referred to as 110 for the convenience of description) that serve as a cloud print client, a cloud print server 120, one or more printing devices 130-1, 130-2, . . . , 130-m (hereinafter referred to as 130 for the convenience of description). It should be noted that the concept of cloud printing herein is described as an example. In fact, the present invention can be applied to network print servers and printing devices capable of connecting to a network beyond a local network, where different terms or concepts may be used.

The computing device 110 may include a desktop computer, a laptop computer, a smart phone, a tablet computer, etc., and use operation systems such as Windows®, IOS® and Android®. On each computing device 110 an application 111 that supports cloud printing functions is installed. The application 111, for example, may be an APP or a web browser, a word processing software and such like running on the operation system. The computing device 110 has access to the cloud print server 120 via a public network based on various types of communication mechanisms, e.g. in all suitable communications such as Ethernet, Wifi and mobile cellular network.

The cloud print server 120 may represent a plurality of servers or a single server. The cloud print server 120 comprises a printing device registration unit 121, a print task management unit 122 and a print task memory 123. The printing device registration unit 121 may establish, in response to a request from the printing device 130, an initial network connection with the printing device 130, register the printing device 130, and create a print task list corresponding to the printing device 130 in the print task memory 123. In order to improve safety, the network connection may be established via VPN. For each registered printing device 130, the print task management unit 122 maintains in the print task memory 121 a print task list corresponding to the printing device 130. Each entry in the print task list may comprise a print task ID and print task content. The print task management unit 122 receives a print request from the computing device 110 and creates a new print task entry in the print task list of the requested printing device 130. When there is a new print task for the printing device 130, the print task management unit 122 may initiatively push the print task ID to the printing device 130, so that the printing device 130 may download the print task and print the same. Alternatively, the print task management unit 122 may also return, in response to a request from the printing device 130 for an inquiry of the print task ID, the latest print task ID to the printing device 130, such that the printing device 130 may download the print task and print the same.

Although the print task memory 121 is shown as an entity part of the cloud print server 120, it should be understood that it may represent a cloud memory device composed of a large number of entity storage distributed in different physical locations. In practice, the cloud print system may be implemented by an architecture including a cloud print server/cloud computing center, local thin server (embedded system local server) and printer/cluster of printers. The cluster of printers may include one or more printers using Epson instruction sets.

The printing device 130 comprises a network initialization unit 131, a print task management unit 132 and a printing unit 133. The network initialization unit 131 may establish a network connection between the printing device 130 and the cloud print server 120 such that the printing device 130 has a corresponding IP address for subsequent secure communication. The printing device 130 may get access to a public network and connect to the cloud print server either via a wired and wireless local network inside of a corporation or a business, or via a 3G or 4G cellular network, etc. During this process, the network initialization unit 131 further registers the printing device 130 at the cloud print server 120 so as for the cloud print server 120 to create and maintain a print task list corresponding to the printing device 130. The print task management unit 132 may comprise a web server for receiving the print task ID pushed by the cloud print server 120 and determine whether a new print task exists. Alternatively, the web server can further inquire of, e.g., by polling, the cloud print server 120 periodically about the print task ID. If it is determined that a new print task exists, the print task management unit 132 will download the new print task from the cloud print server 120 and perform the printing by means of the printing unit 133. It should be noted that the printing device 130 may be either an integral printing device capable of establishing connection with the cloud print server 120 and perform the cloud printing, or a traditional printer added further with an extension device with a cloud printing function, e.g., a cloud printing box. For the latter, the cloud printing box may comprise the network initialization unit 131 and the print task management unit 132, while the traditional printer serves as the printing unit 133. The cloud printing box has a driver for the traditional printer installed therein and is connected with the traditional printer by e.g. Universal Serial Bus (USB). In this way, the corporation or business does not have to buy a new cloud printer but needs only to connect a cloud printing box externally to a traditional printer to turn it into a cloud printer, thus the existing printing device is utilized to an utmost extent, and cost is saved. In a further embodiment, a printing box can be connected to a plurality of traditional printers and hence the cost is further saved.

The cloud printing process according to one embodiment of the present invention will be described as follows in combination with a more specific example.

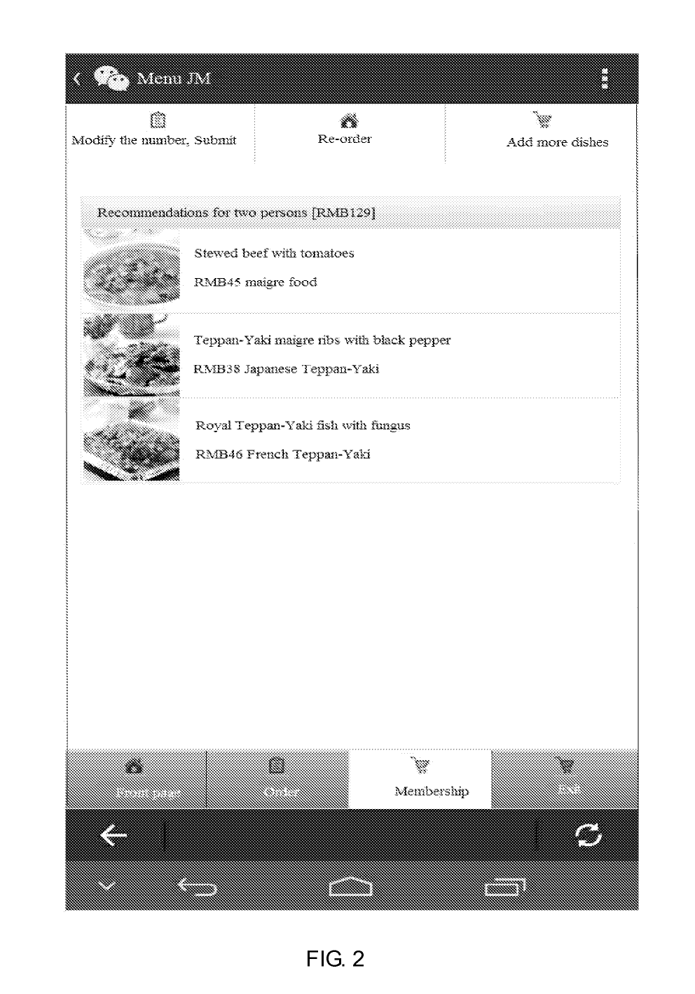

FIG. 2 illustrates a schematic view of a client interface of an online ordering application.

With the prevalence of smart mobile terminals, the user can conveniently download the online ordering application client on a smart phone 110, e.g., from an application store or by scanning a two-dimensional code in a traditional print media advertisement. The online ordering application client communicates with an application server which may be a server identical to or different from the cloud print server 120. The user may carry out a variety of operations on an interface displayed in the application, e.g., browsing menus offered by the business, selecting the desired dishes, then inputting the user information (e.g., telephone number, takeout address, payment method, etc.) and submitting the order. This process may comprise the user's registration process, and the user's account information (e.g., telephone number) may be shared between the application server and the cloud print server 120. When confirming the order, the online ordering application client may read the telephone number of the user from the smart phone and acquired his/her geographical position via GPS and/or the cellular network to thus reduce the user's input and improve the user's experience. When the user submits an order, the application client sends a request to the application server, while the application client and/or the application server send(s) also a print request to the associated cloud print server 120.

It should be noted that there may be more than one print request sent by the application client and/or the application server. For instance, for the above online ordering application, when the user submits an order, it is often necessary to print a triplicate copy, i.e., the reception copy, the client copy and the kitchen copy. The contents of the triplicate can be either as a whole presented in one print request and printed as one print task, or respectively presented in three consecutive print requests and printed as three consecutive print tasks. The following example shows the format of a print request of the kitchen copy.

The print request may comprise information such as the user ID, the business ID, the print content, etc. The print request format of the kitchen copy is exemplified as follows.

id: 75

torder_id: 29

partner_id: 80001250

table id: 797877

content:

BC!-BC! kitchen copy--136

CC!-CC!======80001250======

Print time 2014-04-09 18:11:46

Table No. 797877 order 29 customer service

-------------------------

Entree Olio Noodle with Tomato Sauce

standard

Wheaten Food Chongqing Spicy Chicken

standard

Wheaten Food Royal Sautéed Lamb Slices

standard

-------------------------

has_qrcode: 0

printed: 0

printer_id: 136

create_time: 1397038306

modify_time: 0

The cloud print server 120 may store a mapping table between the business ID and the printing device 130. Alternatively, the mapping table may also be stored in the application server, and then forwarded by the application server to the cloud print server for the latter to inquire about the corresponding printing device of the print request. Alternatively, the application server may translate the business ID in the print request into an ID of the corresponding printing device 130 according to the mapping table. In this case, the print request sent to the cloud print server 120 has already included the ID of the printing device 130. To sum up, the cloud print server 120 may learn about the printing device 130 that corresponds to a print request in different ways. Prior to that, e.g., when the printing device 130 starts up or is connected to the network, the printing device registration unit 121 of the cloud print server 120 has already established an initial network connection with the printing device 130 in response to a request from the printing device 130, verified/registered the printing device 130 and created in the print task memory 123 a print task list corresponding to the printing device 130. The IP address of the printing device 130 is stored in the cloud print server 120. If no connection to or no registration of the target printing device 130 is established, the cloud print server 120 may notify the target printing device 130 to connect to the network for registration in various ways, e.g., by sending GSM messages to the business, or may select an alternative printing device upon strategies. When the cloud print server 120 receives the print request directed to the target printing device 130, the print task management unit 122 adds an entry in the print task list corresponding to the target printing device 130. Apart from e.g. the print task content as shown above, the entry may further comprise a print task ID. The print task ID may be an integer increasing one by one to uniquely identify a print task. Alternatively, the entry may further comprise other identification fields, e.g., has_qrcode: 0 means that the print content does not contain a QR/two-dimensional code, while has_qrcode: 1 means that the print content contains QR/two-dimensional code(s), at which the cloud print server 120 may invoke a code conversion program for conversion. The field printed: 0 means that the print content has not ever been printed; and the field create_time indicates that the print task will be performed after a certain time period, and so on. The cloud print server 120 processes these fields so as to control the printing of the printing device 130. When a printing box is connected to a plurality of printers, the print task entry may further comprise a printer ID for indicating by which printer the print shall be performed.

In a cloud printing by “pull”, the print task management unit 132 of the printing device 130 inquires of the cloud print server 120 periodically about the print task ID, e.g., by polling every n seconds. The print task management unit 122 feeds back the latest print task ID to the printing device 130 in response to the request for the inquiry about the print task ID. The print task management unit 132 compares the inquired print task ID with the current print task ID maintained in the printing device 130, and if the two print task IDs are found inconsistent, requests to download from the cloud print server 120 new print task(s) between the two print task IDs, i.e. print task(s) subsequent to the current print task ID. In this way, new print task(s) can be obtained more rapidly in particular when the cloud print server is considerably burdened with a large number of printing devices.

In a cloud printing by “push”, the print task management unit 122 of the cloud print server 120 pushes a respective print task ID to a printing device 130 periodically or e.g. when a new print task entry is added. The print task management unit 132 of the printing device 130 compares the received print task ID with the current print task ID maintained in the printing device 130, and requests to download from the cloud print server 120 the new print task(s) subsequent to the current print task ID if the two print task IDs are found inconsistent. As compared with the cloud printing by “pull”, it is unnecessary to send a great deal of inquiry messages in the cloud printing by “push”, thereby not only reducing the burden of the cloud print server but also saving the communication traffic cost. A potential problem arising from the cloud printing by “push” is that information pushed by the cloud print server are often intercepted by a firewall set up by a corporation since the printing device is usually situated in an internal network of the corporation. Under such circumstance, the connection between the cloud print server and the printing device may be established via VPN such that the printing device receives the push from the cloud print server via the VPN and bypasses the interception of the firewall, thereby making the cloud printing by “push” feasible.

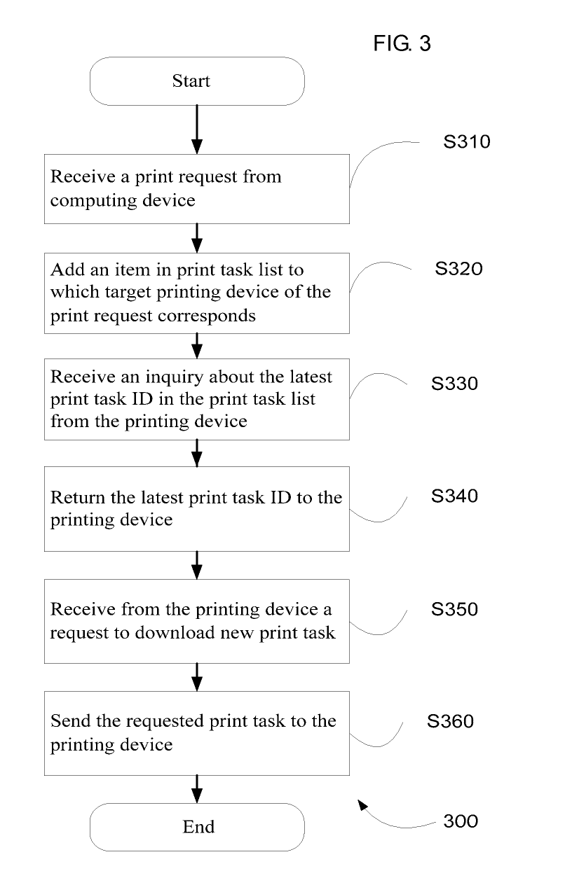

FIG. 3 illustrates a flow chart of a printing method 300 performed by a cloud print server 120 according to an exemplary embodiment of the present invention.

The cloud print server 120 receives a print request from a computing device at step S310, and adds an entry in the print task list to which the target printing device 130 of the print request corresponds at step S320. The entry may comprise a print task ID and print task content. The print task ID may increase one by one or increase by the time stamp. At step S330, the cloud print server 120 receives an inquiry from the printing device 130 about the latest print task ID in the print task list. At step S340, the cloud print server 120 returns the latest print task ID to the printing device 130. At step S350, the cloud print server 120 receives from the printing device 130 a request to download at least one new print task, the at least one new print task corresponding to new print task ID(s) subsequent to the current print task ID maintained in the printing device 130. At step S360, the cloud print server 120 sends the requested print task to the printing device 130.

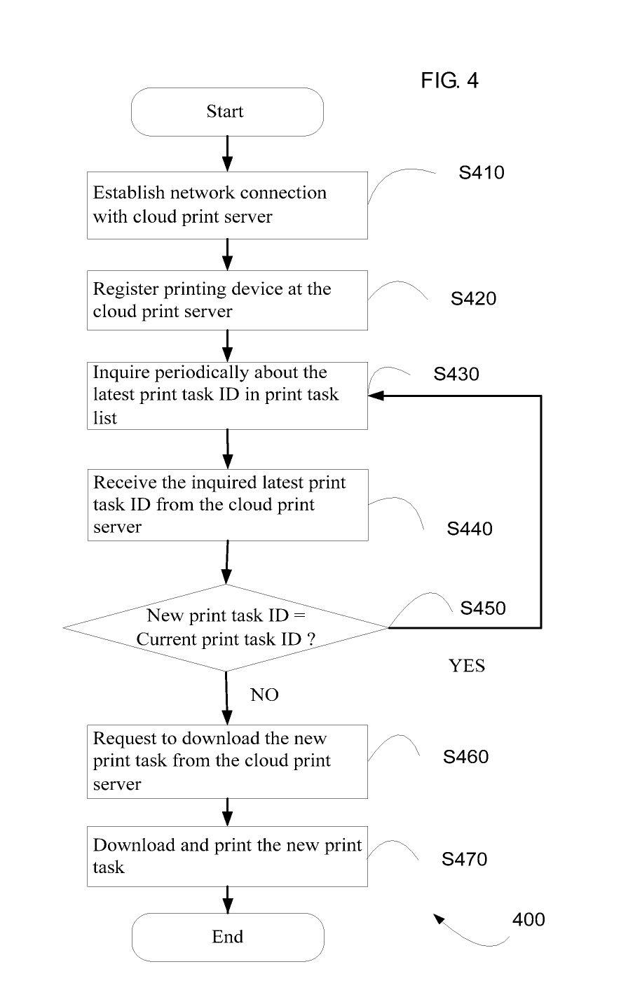

FIG. 4 illustrates a flow chart of a printing method 400 performed by a printing device 130 according to an exemplary embodiment of the present invention.

The printing device 130 establishes a network connection with the cloud print server 120 at step S410, and the printing device registers itself at the cloud print server 120 at step S420. At step S430, the printing device 130 inquires of the cloud print server 120 periodically about the latest print task ID in the print task list. At step S440, the printing device 130 receives the inquired latest print task ID from the cloud print server 120. At step S450, the printing device 130 compares the received latest print task ID with the current print task ID maintained in the printing device 130. If the two print task IDs are inconsistent, it requests at step S460 to download at least one new print task from the cloud print server 120, the at least one new print task corresponding to new print task ID(s) subsequent to the current print task ID maintained in the printing device 130. The printing device 130 downloads and prints the new print task at step S470. If the two print task IDs are consistent, the flow returns to step S430.

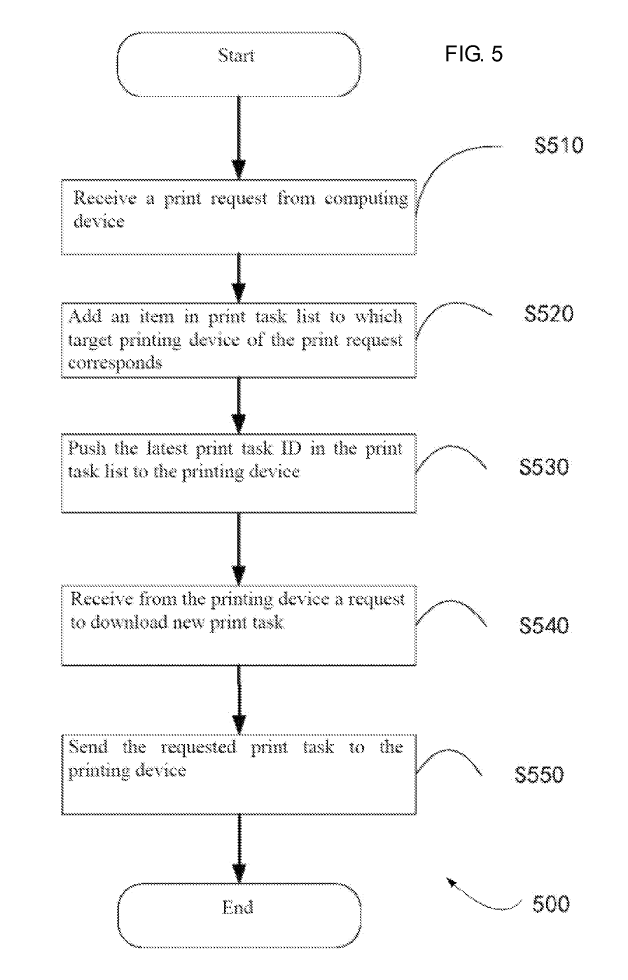

FIG. 5 illustrates a flow chart of a printing method 500 performed by a cloud print server 120 according to another exemplary embodiment of the present invention.

The cloud print server 120 receives a print request from a computing device at step S510, and adds an entry in the print task list to which the target printing device 130 of the print request corresponds at step S520. The entry may comprise a print task ID and print task content. At step S530, the cloud print server 120 pushes the latest print task ID in the print task list to the printing device 130. At step S540, the cloud print server 120 receives from the printing device 130 a request to download at least one new print task, the at least one new print task corresponding to print task ID(s) subsequent to the current print task ID maintained in the printing device 130. At step S550, the cloud print server 120 sends the requested print task to the printing device 130.

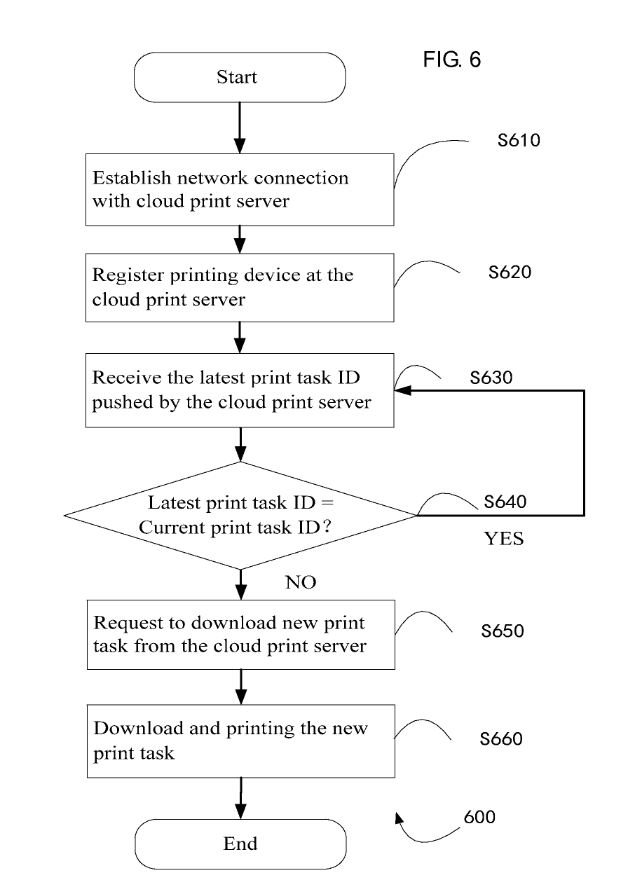

FIG. 6 illustrates a flow chart of a printing method 600 performed by a printing device 130 according to another exemplary embodiment of the present invention.

The printing device 130 establishes a network connection with the cloud print server 120 at step S610. The network connection is preferably via VPN. The printing device 130 is registered at the cloud print server 120 at step S620. At step S630, the printing device receives the latest print task ID in the print task list pushed by the cloud print server 120. At step S640, the printing device 130 compares the received latest print task ID with the current print task ID maintained in the printing device 130. If the two print task IDs are inconsistent, it requests at step S650 to download at least one new print task from the cloud print server 120, the at least one new print task corresponding to print task ID(s) subsequent to the current print task ID maintained in the printing device 130. The printing device 130 downloads and prints the new print task at step S660. If the two print task IDs are consistent, it returns to step S630.

It is to be understood that in order to make the disclosure concise and one or more of the inventive aspects understood, individual features of the present invention are sometimes grouped together into a single embodiment, drawing or description thereof in the above description of the exemplary embodiments of the present invention. However, the disclosed method should not be construed to reflect an intention that the claimed present invention claims more features than those explicitly stated in each claim. More specifically, as reflected in the claims below, the inventive aspect contains less than all features of an individual embodiment disclosed above. Thus, the claims abiding by the detailed description are hereby explicitly incorporated into the specific embodiments, wherein each claim per se serves as a single embodiment of the present invention.

Those skilled in the art should understand that the modules or units or components of the devices in the examples disclosed herein can be arranged in a device as described in the embodiment, or can alternatively be positioned in one or more devices different than the exemplary device. The modules in the aforementioned examples can be combined into one module or beyond this divided into a plurality of sub-modules.

Those skilled in the art can understand that the modules in the devices of the embodiments can be modified adaptively and arranged in one or more devices different than the embodiment. The modules or units or components in the embodiments can be combined into one module or unit or component, and they can be further divided into a plurality of sub-modules or sub-units or sub-components. Any combination of the features and/or process or units can be used to combine all features disclosed in this specification (including the accompanying claims, abstract and drawings) and any method or all processes or units of the devices as such disclosed, except that at least some of such features and/or processes and/or units are repulsive to each other. Unless specified otherwise, each feature disclosed in the present specification (including the accompanying claims, abstract and drawings) can be substituted by a substitutive feature that provides an identical, equivalent or similar goal.

In addition, those skilled in the art can understand that although some embodiments mentioned herein comprise certain features comprised in other embodiments instead of other features, the combination of features from different embodiments implies that they fall within the scope of the present invention and form different embodiments. For example, in the following claims, any one of the claimed embodiments can be used in arbitrary combinations.

In addition, some of the embodiments herein are described as a combination of the methods or method elements implemented by a processor of a computer system or by other devices executing said functions. Therefore, a processor having instructions necessary for implementing the methods or method elements forms a device for implementing the methods or method elements. Moreover, the elements of the device embodiments mentioned herein are examples of devices that are used to implement the functions executed by the elements for implementing the goal of the invention.

As is used herein, unless specified otherwise, the description of an ordinary object with ordinal numbers “first”, “second”, “third” and the like only represents that different instances of similar objects are involved, and is not intended to imply that the objects as such described must have any given orders temporally, spatially, sequentially or in any other manner.

Although the present invention is described in dependence on a limited number of embodiments, owing to the above description, one skilled in the art is aware that other embodiments can be envisaged within the scope of the present invention described herein. In addition, it should be noted that the language used in the present specification is selected for the purpose of readability and teaching, rather than for explaining or defining the subject matter of the invention. Therefore, if not deviating from the scope and spirit of the attached claims, many modifications and changes are clear for those of ordinary skills in the art. For the scope of the present invention, the disclosure of the invention is illustrative, not restrictive, and the scope of the invention is defined by the appended claims.

1. A network print server, comprising:
a print task memory configured to store a print task list;
a printing device registration unit configured to establish, in response to a request of a printing device, a network connection with the printing device, register the printing device and create in the print task memory a print task list corresponding to the printing device; and
a print task management unit configured to receive a print request from a computing device and add a print task entry in the print task list of the requested printing device, the print task entry comprising a print task ID and print task content,
wherein the print task management unit is further configured to receive from the printing device a request to download the print task and send the requested print task to the printing device.

2. The network print server according to claim 1, wherein the print task management unit is further configured to receive an inquiry from the printing device about the latest print task ID in the print task list and returns the latest print task ID to the printing device.

3. The network print server according to claim 1, wherein the print task management unit is further configured to push the latest print task ID in the print task list to the corresponding printing device.

4. The network print server according to claim 2, wherein the print task management unit is further configured to receive from the printing device a request to download at least one new print task, the at least one new print task corresponding to at least one print task ID subsequent to the current print task ID maintained in the printing device, wherein the print task management unit is further configured to send the new print task to the printing device.

5. The network print server according to claim 1, wherein the network connection is established via a virtual private network (VPN).

6. The network print server according to claim 1, wherein the printing device registration unit is configured to notify the printing device to connect to the network for registration or select an alternative printing device if the printing device is not connected or registered.

7. A printing method of a network print server, comprising:
receiving a print request from a computing device;
adding a print task entry in the print task list to which the target printing device of the print request corresponds, the print task entry comprising a print task ID and print task content;
receiving from the printing device a request to download the print task; and
sending the requested print task to the printing device.

8. The method of claim 7, further comprising:
receiving an inquiry from the printing device about the latest print task ID in the print task list, and
returning the latest print task ID to the printing device.

9. The method of claim 7, further comprising pushing the latest print task ID in the print task list to the corresponding printing device.

10. The method of claim 8, wherein the step of receiving from the printing device the request to download the print task comprises receiving from the printing device a request to download at least one new print task, the at least one new print task corresponding to at least one print task ID subsequent to the current print task ID maintained in the printing device, wherein the step of sending the requested print task to the printing device comprises sending the new print task to the printing device.

11. The method of claim 7, further comprising:
establishing, in response to a request of the printing device, a network connection to the printing device, registering the printing device and creating a print task list corresponding to the printing device.

12. The method according to claim 7, wherein the network connection is established via a virtual private network (VPN).

13. The method of claim 11, further comprising:
notifying the printing device to connect to the network for registration or selecting an alternative printing device if the printing device is not connected or registered.

14. The method of claim 7, further comprising:
establishing a network connection to a network print server;
registering the network printing device at the network print server;
comparing the latest print task ID of the printing device provided by the network print server with the current print task ID maintained in the printing device; and
requesting to download at least one new print task from the network print server if the two print task IDs are inconsistent, the at least one new print task corresponding to at least one print task ID subsequent to the current print task ID maintained in the printing device.

15. The method of claim 14, further comprise inquiring of the network print server periodically about the latest print task ID in the print task list and receiving the inquired latest print task ID.

16. A network printing system, comprising a network print server and at least one network printing device,
wherein the network print server comprising:
a print task memory configured to store a print task list;
a printing device registration unit configured to establish, in response to a request of a printing device, a network connection with the printing device, register the printing device and create in the print task memory a print task list corresponding to the printing device; and
a print task management unit configured to receive a print request from a computing device and add a print task entry in the print task list of the requested printing device, the print task entry comprising a print task ID and print task content,
wherein the print task management unit is further configured to receive from the printing device a request to download the print task and send the requested print task to the printing device,
wherein the network printing device comprises:
a network initialization unit configured to establish a network connection between the printing device and a network print server, and register the printing device at the network print server; and
a print task management unit configured to compare the latest print task ID of the printing device provided by the network print server with the current print task ID maintained in the printing device, and request to download a new print task from the network print server if the two print task IDs are inconsistent, the new print task corresponding to the print task ID subsequent to the current print task ID maintained in the printing device.

17. The network printing system according to claim 16, wherein the network printing device further comprises a printing unit configured to perform a print task assigned by the print task management unit.

18. The network printing system according to claim 17, wherein the network initialization unit and the print task management unit are situated in a printing box outside of the printing unit.

19. The network printing system according to claim 16, wherein the print task management unit is further configured to inquire of the network print server periodically about the latest print task ID in a print task list and receive the inquired latest print task ID.

20. The network printing system according to claim 16, wherein the print task management unit is further configured to receive the latest print task ID in the print task list pushed by the network print server.
